(19) United States
(12) Patent Application Publication
(10) Pub. No.: US 2013/0114407 A1
(43) Pub. Date: May 9, 2013

(54) Method and Apparatus for Managing Radio Resources, Radio Network Controller, and Base Station

(71) Applicant: HUAWEI TECHNOLOGIES CO., LTD., Shenzhen (CN)

(72) Inventors: Lin Liu, Shanghai (CN); Yao Yao, Shanghai (CN); Chengyi Wang, Shanghai (CN)

(73) Assignee: HUAWEI TECHNOLOGIES CO., LTD., Shenzhen (CN)

(21) Appl. No.: 13/728,312

(22) Filed: Dec. 27, 2012

Related U.S. Application Data
(63) Continuation of application No. PCT/CN2011/075205, filed on Jun. 2, 2011.

(30) Foreign Application Priority Data
Jun. 29, 2010 (CN) 201010219302.X

(51) Int. Cl. H04W 28/02

(52) U.S. Cl. CPC H04W 28/0268; H04W 28/0289
USPC 370/230

(57) ABSTRACT

Embodiments of the present invention disclose a method and an system for managing radio resources, a radio network controller, and a base station. The method for managing radio resources mainly includes: acquiring respective resources occupied by at least two types of bearers in a cell; comparing the acquired respective resources occupied by the at least two types of bearers; and reducing a congestion threshold of the cell and/or reducing a service rate of the bearer with a low bearer level when it is determined that quality of service (QoS) of the services of different bearers is unfair. The method and the apparatus for managing radio resources, and the radio network controller in the embodiments of the present invention may improve QoS fairness of services of different bearers, thereby preferably implementing management of radio resources.

This application is a continuation of International Application No. PCT/CN2011/075205, filed on Jun. 2, 2011, which claims priority to Chinese Patent Application No. 201010219302.X, filed on Jun. 29, 2010, both of which are hereby incorporated by reference in their entireties.

### TECHNICAL FIELD

The present invention relates to the field of radio communications technologies, and in particular, to a technology for managing radio resources.

### BACKGROUND

A high speed packet access (HSPA) technology includes a high speed downlink packet access (HSDPA) technology and a high speed uplink packet access (HSUPA) technology. The HSDPA may provide a downlink high speed data transmission capability. One of the design principles is that function division between functional entities and logic layers defined in the R99 version is compatible as much as possible, where a structure of the R99 version is kept, and a new MAC (media access control) entity MAC-hs is added in a base station, so as to take charge of scheduling, link adjusting, and HARQ (hybrid automatic retransmission request) controlling functions. The HSUPA may provide an uplink high speed data transmission capability, where the operation needs to use most basic functions of R99 (for example, power control and soft handover). Main features of the HSUPA include 2 ms short frame, physical layer HARQ, and fast scheduling.

As the HSPA is increasingly commercially used, services of different bearers, for example, an R99 service and an HSPA service, may exist in the system. In an existing load control algorithm, when a system load exceeds a certain threshold, congestion control is performed. However, the existing load control algorithm cannot improve QoS (quality of service) fairness of services of different bearers.

### SUMMARY OF THE INVENTION

Embodiments of the present invention provide a method and an apparatus for managing radio resources, and a radio network controller, which are capable of improving QoS fairness of services of different bearers, thereby better implementing management of radio resources.

In one aspect, a method for managing radio resources is provided, where the method mainly includes acquiring respective resources occupied by at least two types of bearers in a cell, comparing the acquired respective resources occupied by the at least two types of bearers to determine whether quality of service (QoS) of the services of different bearers is fair, and reducing a congestion threshold of the cell and/or reducing a service rate of the bearer with a low bearer level when it is determined that the QoS of the services of different bearers is unfair.

In another aspect, a radio communication system comprising an apparatus for managing radio resources is further provided, where the apparatus is configured to acquire respective resources occupied by at least two types of bearers in a cell; compare the respective resources occupied by the at least two types of bearers according to a result of the acquiring module; and when it is determined that quality of service (QoS) of the services of different bearers is unfair according to a comparison result, reduce a congestion threshold of the cell and/or reduce a service rate of the bearer with a low bearer level.

In the embodiments of the present invention, by comparing acquired respective resources occupied by at least two types of bearers, it is determined whether QoS of services of different bearers is fair, and when the QoS of services of different bearers is unfair, a congestion threshold of a cell is reduced, and/or a service rate of the bearer with a low bearer level is reduced, so as to improve QoS fairness of services of different bearers, thereby preferably implementing management of radio resources.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a flow chart of a method for managing radio resources according to an embodiment of the present invention;

FIG. 2 is a flow chart of a method for managing radio resources according to another embodiment of the present invention;

FIG. 3 is a flow chart of a method for managing radio resources according to further another embodiment of the present invention;

FIG. 4 is a schematic structural diagram of an apparatus for managing radio resources according to an embodiment of the present invention;

FIG. 5 is a schematic structural diagram of an apparatus for managing radio resources according to another embodiment of the present invention; and

FIG. 6 is a schematic structural diagram of an apparatus for managing radio resources according to another embodiment of the present invention.

### DETAILED DESCRIPTION OF ILLUSTRATIVE EMBODIMENTS

To make the objectives, technical solutions, and advantages of the present invention more comprehensible, the following describes the technical solutions of the present invention in detail with reference to embodiments and the accompanying drawings.

When at least two types of different bearers exist in a cell, an embodiment of the present invention provides a method for managing radio resources, and as shown in FIG. 1, the method may include the following steps.

S101: Acquire respective resources occupied by at least two types of bearers in a cell.

In a certain cell, multiple types of different bearers may exist, and the types of the bearers may be two or more, for example, R99 and HSPA.

Here, the resources occupied by each type of bearer may be indicated by multiple manners, for example:

A. Average Throughput

When an average throughput is used to indicate the resources occupied by each type of bearer, a service average throughput or a single-user average throughput of each type of bearer may be used for indication.

When the single-user average throughput is used to indicate the resources occupied by each type of bearer, an average throughput of a user with a maximum average throughput in each type of bearer may be used to represent the single-user average throughput of the bearer, and an average throughput of a user with the average throughput being an intermediate value in each type of bearer may also be used to represent the single-user average throughput of the bearer. Particularly, the selection may be made according to actual demands, which is not limited thereto in this embodiment.

When the service average throughput of a certain bearer is acquired, a total bit number of all or a part of services in a first preset period may be divided by the first preset period. The result of the division is the service average throughput. Alternatively, a current bandwidth rate may be acquired, and the current bandwidth rate is used as the service average throughput. The part of services here may be any one or more types of the following: a service with an adequate data source, a service with a scheduling priority higher than a certain threshold, and a service belonging to a certain service type or certain service types. For example, the scheduling priority of a service may be known according to a scheduling priority indicator (SPI) of the service, and then the average throughput of the service with the scheduling priority higher than a certain threshold is acquired, where the threshold here may be set according to actual demands. In addition, the type of service may be identified, so that according to the demands, the average throughput belonging to a certain service type (for example, a session type service) or certain service types (for example, a session type service and a background type service) may be acquired.

When the single-user average throughput is acquired, the average throughput of the user in the preset period is considered.

For the different bearers, the manner of acquiring the service average throughput or the single-user average throughput in each type of bearer may be different. For each type of bearer, multiple manners of acquiring the service average throughput or the single-user average throughput may exist, which are illustrated through examples in subsequent embodiments in the application.

B. Average Bandwidth

When an average bandwidth is used to indicate the resources occupied by each type of bearer, a service average bandwidth or a single-user average bandwidth of each type of bearer may be used for indication.

The service average bandwidth of each type of bearer may be acquired in the following manner: a total bandwidth of all or a part of services in a second preset period is divided by the second preset period. The result of the division is the service average throughput. The part of services here may be any one or more types of the following: a service with an adequate data source, a service with a scheduling priority higher than a certain threshold, and a service belonging to a certain service type or certain service types. For example, the scheduling priority of the service may be known according to a scheduling priority indicator (SPI) of the service, and then the average bandwidth of the service with the scheduling priority higher than a certain threshold is acquired, where the threshold here may be set according to actual demands. In addition, the type of a service may be identified, so that according to the demands, the average bandwidth of the service belonging to a certain service type (for example, a session type service) or certain service types (for example, a session type service and a background type service) may be acquired.

When the single-user average bandwidth is used to indicate the occupied resources, an average bandwidth of a user with a maximum average bandwidth in each type of bearer may be used to represent the single-user average bandwidth of the bearer, and an average bandwidth of a user with the average bandwidth being an intermediate value in each type of bearer may also be used to represent the single-user average bandwidth of the bearer. Particularly, the selection may be made according to actual demands, which is not limited thereto in this embodiment.

For the different bearers, the manner of acquiring the service average bandwidth or the single-user average bandwidth in each type of bearer may be different. For each type of bearer, multiple manners of acquiring the service average bandwidth or the single-user average bandwidth may exist, which are illustrated through examples in subsequent embodiments in the application.

C. Ratio of an Average Throughput to a Guaranteed Rate

When the ratio of an average throughput to a guaranteed rate is used to indicate the resources occupied by each type of bearer, the ratio of the service average throughput to the guaranteed rate or the ratio of the single-user average throughput to the guaranteed rate in each type of bearer is used for indication.

When the ratio of the single-user average throughput to the guaranteed rate is used to indicate the resources occupied by each type of bearer, the ratio of the average throughput to the guaranteed rate of a user with a maximum ratio of the average throughput to the guaranteed rate in each type of bearer may be used for indication, and the ratio of the average throughput to the guaranteed rate of a user with the ratio of the average throughput to the guaranteed rate being an intermediate value in each type of bearer may also be used for indication. Particularly, the selection may be made according to actual demands, which is not limited thereto in this embodiment.

For the different bearers, the manner of acquiring the ratio of the service average throughput to the guaranteed rate or the ratio of the single-user average throughput to the guaranteed rate in each type of bearer may be different. For each type of bearer, multiple manners of acquiring the ratio of the service average throughput to the guaranteed rate or the ratio of the single-user average throughput to the guaranteed rate may exist, which are illustrated through examples in subsequent embodiments in the application. It may be understood that, after the service average throughput or the single-user average throughput is acquired, the ratio of the service average throughput to the guaranteed rate or the ratio of the single-user average throughput to the guaranteed rate is calculated, and the manner of acquiring the service average throughput or the single-user average throughput may be similar to the manner described in the foregoing relevant embodiment.

S102: Compare the acquired respective resources occupied by the at least two types of bearers.

As described above, multiple manners of indicating the occupied resources may exist. When the resources occupied by the different bearers are compared, each bearer adopts a consistent manner of indicating the occupied resources.

By comparing the resources occupied by the bearers, it may be known whether QoS of the services of different bearers is fair. For example, the at least two types of bearers in this embodiment include the bearer with a low bearer level and the bearer with a high service throughput. If a difference between the resources occupied by the bearer with the low bearer level and the resources occupied by the bearer with the high bearer level is greater than or equal to a first threshold, or if the ratio of the resources occupied by the bearer with the low bearer level to the resources occupied by the bearer with the high bearer level is greater than or equal to a second threshold, it is considered that the QoS of the services of different bearers is unfair.

If it is considered that the QoS of the services of different bearers is unfair, S103 is executed; otherwise, no processing is performed, and the procedure ends.

Here, it should be illustrated that for different manners of indicating the occupied resources, values of the first threshold and the second threshold may be the same or different. The first threshold may be set to any numerical value greater than 0, and the second threshold may be set to any numerical value greater than 1. The numerical values of the first threshold and the second threshold may be set according to actual demands, for example, may be set according to demands of an operator, which is not limited thereto in this embodiment.

For each type of bearer, a level (called a bearer level) may be determined in multiple manners, and the bearer level of each type of bearer may be determined according to an actual situation or may be set according to the demands of the operator, for example, under a certain situation, the bearer level of R99 is lower than that of HSPA, and under a certain situation, the bearer level of R99 may be higher than that of HSPA.

The bearer level of a bearer may be determined according to an average throughput demand of all or a part of services in the bearer, an average priority of all or a part of users in the bearer, an average scheduling priority of all or a part of services in the bearer, or a sum of throughput demands of all or a part of services in the bearer. The bearer with a high average throughput demand of all or a part of services in the bearer has a high bearer level, or the bearer with a high average priority of all or a part of users in the bearer has a high bearer level, or the bearer with a high average scheduling priority of all or a part of services in the bearer has a high bearer level, or the bearer with a high sum of throughput demands of all or a part of services in the bearer has a high bearer level.

The part of users here may be selected according to actual demands (for example, the user with the load greater than a certain threshold is selected), and the part of services may also be selected according to actual demands (for example, the services belonging to a certain service type or certain service types are selected), which is not limited thereto in this embodiment.

In addition, the operator may also directly raise requirements for each bearer, so the bearer level may be determined according to the requirements of the operator. The operator may require the priorities of different bearers, and the required priorities may be required through multiple aspects, for example, through the throughputs of different bearers.

S103: Reduce a congestion threshold of the cell and/or reduce a service rate of the bearer with a low bearer level.

In one aspect, by reducing the congestion threshold of the cell, a congestion releasing action may be triggered in advance, where the congestion releasing action may include service rate reduction, inter-frequency load switching, uncontrollable real-time service QoS renegotiation, inter-system handover, and adaptive multi-rate (AMR) service rate reduction, so as to improve QoS fairness of the services of different bearers.

In another aspect, by reducing the service rate of the bearer with the low bearer level, the QoS fairness of the services of different bearers may also be improved.

It may be understood that one of the two manners of reducing the congestion threshold of the cell and reducing the service rate of the bearer with the low bearer level may be selected to improve the QoS fairness of the services of different bearers, or the two manners may be executed simultaneously, which is not limited thereto in this embodiment.

Further, before S102 or S103 is executed, it may be determined whether the load of the cell is smaller than the congestion threshold of the cell, and if the load of the cell is smaller than the congestion threshold of the cell, the procedure is continued, so as to prevent repeated adjustment.

In the method for managing radio resources of this embodiment, by comparing the acquired respective resources occupied by the at least two types of bearers, it is determined whether the QoS of the services of different bearers is fair, and if the QoS of the services of different bearers is unfair, the congestion threshold of the cell is reduced and/or the service rate of the bearer with the low bearer level is reduced, so as to improve the QoS fairness of the services of different bearers, thereby preferably implementing management of radio resources.

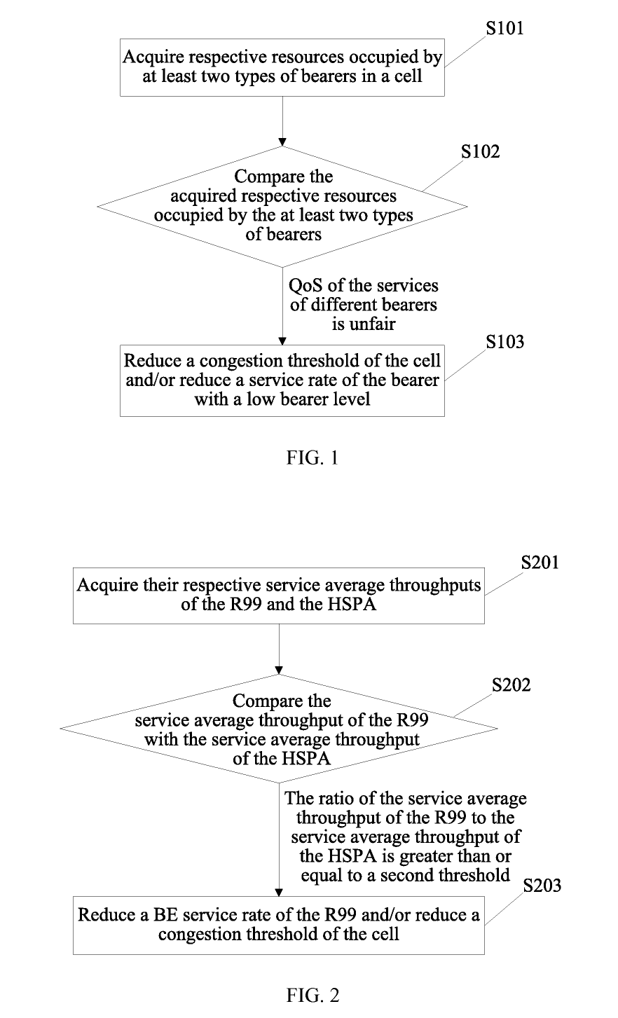

In the following, a cell having two types of bearers being R99 and HSPA is taken as an example for illustration, and it is assumed that a bearer level of the R99 is known to be lower than that of the HSPA according to a sum of throughput demands of all services. As shown in FIG. 2, another embodiment of the present invention provides a method for managing radio resources, and in the method, an average throughput of services in each type of bearer is used to indicate resources occupied by each type of bearer. The method may include the following steps:

S201: Acquire their respective service average throughputs of the R99 and the HSPA.

The HSPA here may be HSUPA or HSDPA, which is collectively called the HSPA in this embodiment.

It should be illustrated that in different bearers, manners of acquiring the service average throughput may be different. For example, for a best effort (BE) service in the R99, the manner of acquiring the service average throughput may be: dividing a total bit number in a preset period by the preset period; for the HSPA service, an average effective rate of the HSPA service with an adequate data source in the preset period may be used to indicate the service average throughput in the HSPA. When the service average throughput is calculated, the preset period may be set according to actual demands, for example, may be set to 8s or other numerical values, which is not limited thereto in this embodiment. Further, when the preset period is set, the processing load for a processor may be considered, so as to improve QoS fairness of users of different bearers without bringing too heavy processing load to the processor.

S202: Compare the service average throughput of the R99 with the service average throughput of the HSPA.

In this embodiment, it is assumed that the bearer level of the R99 is lower than that of the HSPA, and a difference between the two is measured by using the ratio of the service average throughput of the R99 to the service average throughput of the HSPA. The service average throughput of the R99 in S201 is compared with the service average throughput of the HSPA, and if the ratio of the service average throughput of the R99 to the service average throughput of the HSPA is greater than or equal to a second threshold (where the second threshold may be any numerical value greater than 1, for example, 1.2), S203 is executed.

S203: Reduce a BE service rate of the R99 and/or reduce a congestion threshold of the cell.

In one aspect, by reducing the congestion threshold of the cell, a congestion releasing action may be triggered in advance, where the congestion releasing action may include BE service rate reduction, inter-frequency load switching, uncontrollable real-time service QoS renegotiation, inter-system handover, and AMR service rate reduction, so as to improve QoS fairness of the services of different bearers.

In another aspect, by reducing the BE service rate of the R99, the QoS fairness of the services of different bearers may also be improved.

It may be understood that one of the two manners of reducing the congestion threshold of the cell and reducing the BE service rate of the R99 may be selected to improve the QoS fairness of the services of different bearers, or the two manners may be executed simultaneously, which is not limited thereto in this embodiment.

In addition, it should be illustrated that two types of bearers are taken as an example for illustration in the foregoing, and for a situation that a cell has more bearers, the load control manner is similar, which is not exemplified in this embodiment. In addition to the two types of bearers being the R99 and the HSPA exemplified in this embodiment, other bearers may also exist, for example, MIMO (multiple-input multiple-output), DC-HSPA (dual cell HSPA), and other HSPA+ (evolution of the HSPA) bearers. Besides, in the embodiment of the present invention, in addition to that two types of bearers coexist in the cell, more types of bearers may exist, and for the situation that the cell has more types of bearers, the method for managing radio resources is similar, which is not exemplified in this embodiment.

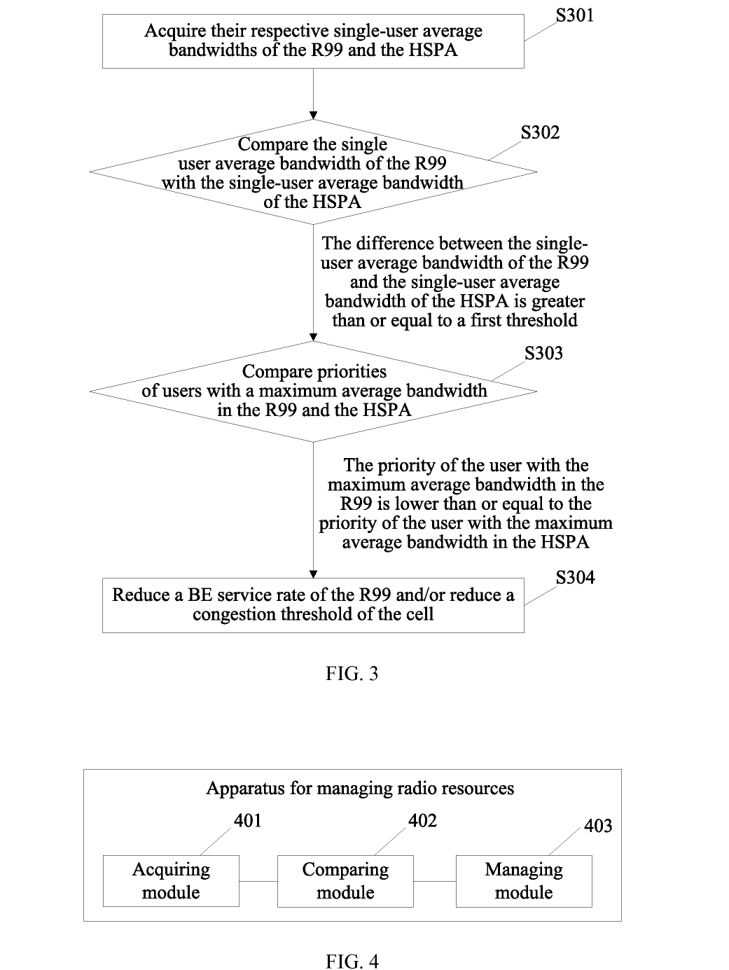

Further, in the method for managing radio resources of this embodiment, priorities of users may be considered, that is, priorities of users corresponding to resources occupied by each type of bearer are compared. As shown in FIG. 3, another embodiment of the present invention provides a method for managing radio resources. In the embodiment, it is assumed that a cell has two types of bearers being R99 and HSPA, and it is assumed that a bearer level of the R99 is known to be lower than that of the HSPA according to an average throughput demand of all services; and a user with a maximum average bandwidth is used to represent a single-user average bandwidth of the bearer. The method may include the following steps:

S301: Acquire their respective single-user average bandwidths of the R99 and the HSPA.

Here, an average value of a bandwidth occupied by a certain user in a period of time is used to indicate an average bandwidth of the user, a user with a maximum average bandwidth in the R99 is used to represent the single-user average bandwidth of the R99, and a user with a maximum average bandwidth in the HSPA is used to represent the single-user average bandwidth of the HSPA.

S302: Compare the single-user average bandwidth of the R99 with the single-user average bandwidth of the HSPA.

In this embodiment, it is assumed that the bearer level of the R99 is lower than that of the HSPA, and the difference between the two is measured by using a difference between the single-user average bandwidth of the R99 and the single-user average bandwidth of the HSPA. The single-user average bandwidth of the R99 in S301 is compared with the single-user average bandwidth of the HSPA, and if the difference between the single-user average bandwidth of the R99 and the single-user average bandwidth of the HSPA is greater than or equal to a first threshold (where the first threshold may be any numerical value greater than 0, for example, 64 kbit/s), S303 is executed.

S303: Compare priorities of users with a maximum average bandwidth in the R99 and the HSPA.

When the difference between the single-user average bandwidth of the R99 and the single-user average bandwidth of the HSPA is greater than or equal to the first threshold, it is considered that QoS of the services of different bearers may be unfair. Here, the priorities of the users used to measure the single-user average bandwidth in each bearer may be further compared. If the priority of the users of the bearer with the low bearer level (R99 in this embodiment) is lower than or equal to the priority of the users of the bearer with the high bearer level (HSPA in this embodiment), S304 is executed, and if the priority of the users of the bearer with the low bearer level is higher than the priority of the users of the bearer with the high bearer level, the QoS fairness of the services of different bearers may not be improved.

The R99 and the HSPA of this embodiment are taken as an example, that is, if the priority of the user with the maximum average bandwidth in the R99 is lower than or equal to the priority of the user with the maximum average bandwidth in the HSPA, S304 is executed, and if the priority of the user with the maximum average bandwidth in the R99 is higher than the priority of the user with the maximum average bandwidth in the HSPA, the QoS fairness of the services of different bearers may not be improved.

It may be understood that the execution sequence of S303 and S302 may be exchanged.

S304: Reduce a BE service rate of the R99 and/or reduce a congestion threshold of the cell.

It should be illustrated that in this embodiment, using the single-user average bandwidth to indicate the resources occupied by the bearer is taken as an example for illustration, and for other scenarios, the priority of the user may also be considered. If the number of the users corresponding to the resources occupied by each type of bearer is greater than 1, the priority of the users corresponding to the resources occupied by each type of bearer is an average priority of all the users corresponding to the resources occupied by the bearer. Here, the users corresponding to the resources occupied by each type of bearer refer to the users mentioned when the resources occupied by each type of bearer are acquired, for example, it is assumed that the average throughput of all the services is used to indicate the resources occupied by the bearer, and the users corresponding to all the services are the users corresponding to the resources occupied by the bearer.

In this embodiment, when the QoS fairness of different bearers is guaranteed, the QoS fairness of the users with the different priorities may be considered at the same time, for example, the user with the high priority is enabled to have the higher QoS.

An embodiment of the present invention further provides an apparatus for managing radio resources, and as shown in FIG. 4, the apparatus may include an acquiring module 401, configured to acquire respective resources occupied by at least two types of bearers in a cell, a comparing module 402, configured to compare the respective resources occupied by the at least two types of bearers according to a result of the acquiring module 401, and a managing module 403, configured to: according to a comparison result of the comparing module 402, reduce a congestion threshold of the cell and/or reduce a service rate of the bearer with a low bearer level, when a difference between the resources occupied by the bearer with a low bearer level and the resources occupied by the bearer with a high bearer level or the ratio of the resources occupied by the bearer with a low bearer level to the resources occupied by the bearer with a high bearer level is greater than or equal to a corresponding threshold.

In one aspect, by reducing the congestion threshold of the cell, a congestion releasing action may be triggered in advance, so as to improve QoS fairness of the services of different bearers.

In another aspect, by reducing the service rate of the bearer with the low bearer level, the QoS fairness of the services of different bearers may also be improved.

It may be understood that one of the two manners of reducing the congestion threshold of the cell and reducing the service rate of the bearer with the low bearer level may be selected to improve the QoS fairness of the services of different bearers, or the two manners may be executed simultaneously, which is not limited thereto in this embodiment.

As described in the method embodiment, in a certain cell, multiple types of different bearers may exist, and the types of the bearers may be two or more, for example, R99 and HSPA. The resources occupied by each type of bearer may be indicated by multiple manners, for example, an average throughput, an average bandwidth, or the ratio of the average throughput to a guaranteed rate. Further, the acquiring module 401 may include a first acquiring sub-module, configured to acquire their respective service average throughputs of the at least two types of bearers in the cell, or a second acquiring sub-module, configured to acquire their respective single-user average throughputs of the at least two types of bearers in the cell, or a third acquiring sub-module, configured to acquire their respective service average bandwidths of the at least two types of bearers in the cell, or a fourth acquiring sub-module, configured to acquire their respective single-user average bandwidths of the at least two types of bearers in the cell, or a fifth acquiring sub-module, configured to acquire the ratio of their respective service average throughputs of the at least two types of bearers in the cell to a guaranteed rate, or a sixth acquiring sub-module, configured to acquire the ratio of their respective single-user average throughputs of the at least two types of bearers in the cell to a guaranteed rate.

For introduction and acquiring manners for the service average throughput, the single-user average throughput, the service average bandwidth, the single-user average bandwidth, the ratio of the service average throughput to the guaranteed rate, and the ratio of the single-user average throughput to the guaranteed rate, reference is made to the relevant description in the method embodiment, which is not described here.

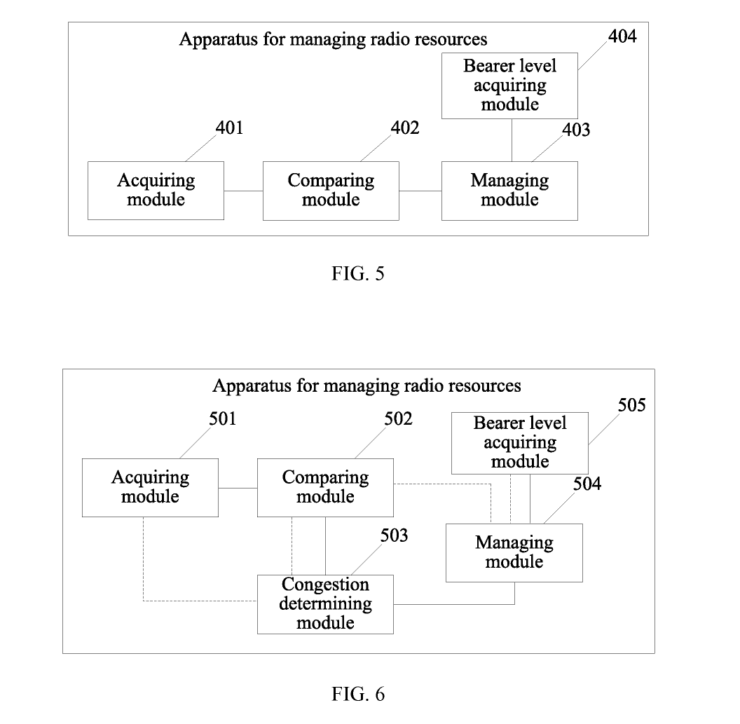

The bearer level of each type of bearer may be acquired according to an actual situation or set according to demands of an operator. For example, under certain situations, the bearer level of R99 is lower than that of HSPA, and under certain situations, the bearer level of R99 may be higher than that of HSPA. As shown in FIG. 5, an apparatus for managing radio resources according to another embodiment of the present invention further includes: a bearer level acquiring module 404, configured to acquire the bearer levels of the at least two types of bearers. The bearer level acquiring module may directly acquire the bearer level of each bearer according to the demands of the operator, or may determine the bearer level of each bearer according to the actual situation. Particularly, reference is made to the relevant description in the method embodiment. Further, the bearer level acquiring module 404 may include a first bearer level acquiring sub-module, configured to determine the bearer level according to an average throughput demand of all or a part of services in a bearer, where the bearer level of the bearer with a high average throughput demand of all or a part of services in a bearer is higher than the bearer level of the bearer with a low average throughput demand of all or a part of services in a bearer, or a second bearer level acquiring sub-module, configured to determine the bearer level according to an average priority of all or a part of users in a bearer, where the bearer level of the bearer with a high average priority of all or a part of users in a bearer is higher than the bearer level of the bearer with a low average priority of all or a part of users in a bearer, or a third bearer level acquiring sub-module, configured to determine the bearer level according to a scheduling priority of all or a part of services in a bearer, where the bearer level of the bearer with a high average scheduling priority of all or a part of services in the bearer is higher than the bearer level of the bearer with a low average scheduling priority of all or a part of services in a bearer, or a fourth bearer level acquiring sub-module, configured to acquire the bearer level according to demands of an operator, where the bearer level of the bearer with a high priority of the demands of the operator is higher than the bearer level of the bearer with a low priority of the demands of the operator, or a fifth bearer level acquiring sub-module, configured to determine the bearer level according to a sum of throughput demands of all or a part of services in the bearer, where the bearer level of the bearer with a high sum of throughput demands of all or a part of services in a bearer is higher than the bearer level of the bearer with a low sum of throughput demands of all or a part of services in a bearer.

In the apparatus for managing radio resources of this embodiment, by comparing the acquired respective resources occupied by the at least two types of bearers, it is determined whether the QoS of the services of different bearers is fair, and if the QoS of the services of different bearers is unfair, the congestion threshold of the cell is reduced and/or the service rate of the bearer with the low bearer level is reduced, so as to improve the QoS fairness of the services of different bearers, thereby preferably implementing management of radio resources.

Further, in order to prevent the repeated adjustment, before the acquired respective resources occupied by the at least two types of bearers are compared, or the congestion threshold of the cell is reduced, and/or the service rate of the bearer with the low bearer level is reduced, it is determined whether a load of the cell is smaller than the congestion threshold of the cell. Another embodiment of the present invention further provides an apparatus for managing radio resources, and as shown in FIG. 6, the apparatus may include: an acquiring module 501, a comparing module 502, a congestion determining module 503, and a managing module 504, where the acquiring module 501 is configured to acquire respective resources occupied by at least two types of bearers in a cell, the comparing module 502 is configured to compare the respective resources occupied by the at least two types of bearers according to a result of the acquiring module 501, and the congestion determining module 503 is configured to determine whether a load of the cell is smaller than a congestion threshold of the cell, where if the load of the cell is smaller than the congestion threshold of the cell, the managing module 504 is configured to: according to a comparison result of the comparing module 502, reduce the congestion threshold of the cell and/or reduce a service rate of the bearer with a low bearer level, when a difference between the resources occupied by the bearer with a low bearer level and the resources occupied by the bearer with a high bearer level or the ratio of the resources occupied by the bearer with the low bearer level to the resources occupied by the bearer with a high bearer level is greater than or equal to a corresponding threshold.

It should be illustrated that the congestion determining module 503 may also determine whether the load of the cell is smaller than the congestion threshold of the cell before the comparing module 502 compares the respective resources occupied by the at least two types of bearers, and if the load of the cell is smaller than the congestion threshold of the cell, the comparing module 502 compares the respective resources occupied by the at least two types of bearers. Solid lines and dashed lines in FIG. 6 respectively indicate two types of possible connection relations.

The apparatus for managing radio resources in this embodiment may also include a bearer level acquiring module 505, configured to acquire the bearer levels of the at least two types of bearers. For the bearer level acquiring module 505, reference is made to the description relevant to the bearer level acquiring module 404 in the embodiment as shown in FIG. 5.

In addition, in order to guarantee the QoS fairness of different bearers and consider the QoS fairness of users with different priorities at the same time, another embodiment of the present invention further provides an apparatus for managing radio resources, and on the basis of the apparatus for managing radio resources as shown in FIG. 4, FIG. 5, or FIG. 6, the apparatus may include a priority comparing module, where the priority comparing module is configured to: before the comparing module 402 or the comparing module 502 compares the respective resources occupied by the at least two types of bearers, compare priorities of users corresponding to the resources occupied by the at least two types of bearers, where if the priority of the users corresponding to the resources occupied by the bearer with a low bearer level is lower than or equal to the priority of the users corresponding to the resources occupied by the bearer with a high bearer level, the comparing module 402 or the comparing module 502 compares the respective resources occupied by the at least two types of bearers, or the priority comparing module is configured to: before the managing module 403 or the managing module 504 reduces the congestion threshold of the cell and/or reduces the service rate of the bearer with a low bearer level, compare priorities of users corresponding to the resources occupied by the at least two types of bearers, where if the priority of the users corresponding to the resources occupied by the bearer with the low bearer level is lower than or equal to the priority of the users corresponding to the resources occupied by the bearer with a high bearer level, the managing module 403 or the managing module 504 reduces the congestion threshold of the cell and/or reduces the service rate of the bearer with the low bearer level.

For the implementation manners and the interaction processes of each module in the apparatus, reference is made to the corresponding description in the method embodiment, which is not described here.

An embodiment of the present invention further provides a radio network controller, where the radio network controller may include the apparatus for managing radio resources in any one of the embodiments of the apparatus for managing radio resources.

An embodiment of the present invention further provides a base station, where the base station may include the apparatus for managing radio resources in any one of the embodiments of the apparatus for managing radio resources. The base station may be a NodeB or an eNodeB.

The described apparatus or system embodiments are merely exemplary. The units described as separate parts may or may not be physically separate, and parts displayed as units may or may not be physical units, may be located in one position, or may be distributed on multiple network elements. A part of or all of the modules may be selected according to the actual needs to achieve the objectives of the solutions of the embodiments. Persons of ordinary skill in the art may understand and implement the embodiment without creative efforts.

It should be noted that the relational terms herein such as first and second are used only to differentiate an entity or operation from another entity or operation, and do not require or imply any actual relationship or sequence between these entities or operations. Moreover, the terms “include”, “comprise”, and any variation thereof are intended to cover a non-exclusive inclusion. Therefore, in the context of a process, method, object, or device that includes a series of elements, the process, method, object, or device not only includes such elements, but also includes other elements not specified expressly, or may include inherent elements of the process, method, object, or device. If no more limitations are made, an element limited by “include a/an . . . ” does not exclude other same elements existing in the process, the method, the object, or the device which includes the element.

Persons of ordinary skill in the art may understand that all or a part of the steps of the method according to the embodiments may be implemented by a program instructing relevant hardware. The program may be stored in a computer readable storage medium, and the storage medium may be a read-only memory, a magnetic disk, or an optical disk, and the like.

The objectives, technical solutions, and benefits of the present invention are further described in detail in the foregoing specific embodiments. It should be understood that the foregoing descriptions are only specific embodiments of the present invention, but are not intended to limit the protection scope of the present invention. Any modification, equivalent replacement, or improvement made within the spirit and principle of the present invention shall fall within the protection scope of the present invention.

What is claimed is:

1. A method for managing radio resources, comprising:
acquiring respective resources occupied by different bearers in a cell, the different bearers comprising at least two types of bearers;
comparing the acquired respective resources occupied by the different bearers to determine whether a difference between quality of services (QoSs) provided by the different bearers exceeds a threshold; and
reducing a congestion threshold of the cell or reducing a service rate of at least one of the different bearers when the difference between QoS provided by the different bearers exceeds the threshold.

2. The method according to claim 1, wherein comparing the acquired respective resources to determine whether the difference between QoSs provided by the different bearers exceeds a threshold comprises:
determining whether a difference between resources occupied by at least two of the different bearers is greater than or equal to a threshold.

3. The method according to claim 1, wherein acquiring the respective resources occupied by the different bearers comprises:
acquiring respective average service throughputs of the different bearers in the cell; or
acquiring respective average single-user throughputs of the different bearers in the cell; or
acquiring respective average service bandwidths of the different bearers in the cell; or
acquiring respective average single-user bandwidths of the different bearers in the cell; or
acquiring a ratio of respective average service throughputs of the different bearers in the cell to a guaranteed rate; or
acquiring a ratio of respective average single-user throughputs of the different bearers in the cell to a guaranteed rate.

4. The method according to claim 3, wherein the average single-user average throughput is acquired by:
determining a user with a maximum average throughput in each type of bearer, and using an average throughput of the user with the maximum average throughput in each type of bearer as the average single-user throughput of each type of bearer; or
determining a user with an average throughput being an intermediate value in each type of bearer, and using an average throughput of the user with the average throughput being the intermediate value in each type of bearer as the average single-user throughput of each type of bearer.

5. The method according to claim 3, wherein the average single-user bandwidth is acquired by:
determining a user with a maximum average bandwidth in each type of bearer, and using an average bandwidth of the user with the maximum average bandwidth in each type of bearer as the average single-user bandwidth of each type of bearer; or
determining a user with an average bandwidth being an intermediate value in each type of bearer, and using an average bandwidth of the user with the average bandwidth being the intermediate value in each type of bearer as the average single-user bandwidth of each type of bearer.

6. The method according to claim 3, wherein a ratio of the average single-user throughput to the guaranteed rate is acquired by:
determining a user with a maximum ratio of the average throughput to the guaranteed rate in each type of bearer, and using the ratio of the average throughput to the guaranteed rate, of the user with the maximum ratio of the average throughput to the guaranteed rate in each type of bearer, as the ratio of the average single-user throughput to the guaranteed rate of each type of bearer; or
determining a user with the ratio of the average throughput to the guaranteed rate being an intermediate value in each type of bearer, and using the ratio of the average throughput to the guaranteed rate, of the user with the ratio of the average throughput to the guaranteed rate being the intermediate value in each type of bearer, as the ratio of the average single-user throughput to the guaranteed rate of each type of bearer.

7. The method according to claim 1, further comprising:
before the comparing the acquired respective resources occupied by the different bearers, determining whether a load of the cell is smaller than the congestion threshold of the cell, and if the load of the cell is smaller than the congestion threshold of the cell, executing the step of comparing the acquired respective resources occupied by the different bearers; or
before the reducing the congestion threshold of the cell and/or reducing the service rate of the bearer with the low bearer level, determining whether a load of the cell is smaller than the congestion threshold of the cell, and if the load of the cell is smaller than the congestion threshold of the cell, executing the step of reducing the congestion threshold of the cell and/or reducing the service rate of the bearer with the low bearer level.

8. The method according to claim 1, further comprising:
before the comparing the acquired respective resources occupied by the different bearers, comparing priorities of users corresponding to the resources occupied by the different bearers, and if a priority of users corresponding to the resources occupied by the bearer with the low bearer level is lower than or equal to a priority of users corresponding to the resources occupied by the bearer with the high bearer level, executing the step of comparing the acquired respective resources occupied by the different bearers; or
before the reducing the congestion threshold of the cell and/or reducing the service rate of the bearer with the low bearer level, comparing priorities of users corresponding to the resources occupied by the different bearers, and if a priority of users corresponding to the resources occupied by the bearer with the low bearer level is lower than or equal to a priority of users corresponding to the resources occupied by the bearer with the high bearer level, executing the step of reducing the congestion threshold of the cell and/or reducing the service rate of the bearer with the low bearer level,
wherein when the number of users corresponding to resources occupied by each type of bearer is greater than 1, a priority of the users corresponding to the resources occupied by each type of bearer is an average priority of all users corresponding to the resources occupied by the bearer.

9. The method according to claim 1, comprising: determining the bearer level according to demands of an operator, an average throughput demand of all or a part of services in a bearer, an average priority of all or a part of users in the bearer, a scheduling priority of all or a part of services in the bearer, or a sum of throughput demands of all or a part of services in the bearer.

10. The method according to claim 1, wherein the different bearers comprise: R99 and high speed packet access (HSPA).

11. The method according to claim 10, wherein the bear level of HSPA is higher than R99.

12. A radio communication system comprising an apparatus for managing radio resources, wherein the apparatus is configured to
acquire respective resources occupied by different bearers in a cell, wherein the different bearers comprises at least two types of bearers;
compare the respective resources occupied by the different bearers; and
reduce a congestion threshold of the cell or reduce a service rate of at least one of the different bearers when a difference between quality of services (QoSs) provided by the different bearers exceeds a threshold.

13. The system according to claim 12, wherein comparing the acquired respective resources to determine whether the difference between QoSs provided by the different bearers exceeds a threshold comprises:
determining whether a difference between resources occupied by at least two of the different bearers is greater than or equal to a threshold.

14. The system according to claim 12, wherein acquiring the respective resources occupied by the different bearers comprises:
acquiring respective average service throughputs of the different bearers in the cell; or
acquiring respective average single-user throughputs of the different bearers in the cell; or
acquiring respective average service bandwidths of the different bearers in the cell; or
acquiring respective average single-user bandwidths of the different bearers in the cell; or
acquiring a ratio of respective average service throughputs of the different bearers in the cell to a guaranteed rate; or
acquiring a ratio of respective average single-user throughputs of the different bearers in the cell to a guaranteed rate.

15. The system according to claim 12, the apparatus is further configured to,
before comparing the respective resources occupied by the different bearers, determine whether a load of the cell is smaller than the congestion threshold of the cell, wherein if the load of the cell is smaller than the congestion threshold of the cell, the apparatus compares the respective resources occupied by the different bearers; or
before the reducing the congestion threshold of the cell and/or reduces the service rate of the bearer with the low bearer level, determine whether a load of the cell is smaller than the congestion threshold of the cell, wherein if the load of the cell is smaller than the congestion threshold of the cell, the apparatus reduces the congestion threshold of the cell and/or reduces the service rate of the bearer with the low bearer level.

16. The system according to claim 12, the apparatus is further configured to
before the comparing the respective resources occupied by the different bearers, compare priorities of users corresponding to the resources occupied by the different bearers, wherein if a priority of users corresponding to the resources occupied by the bearer with the low bearer level is lower than or equal to a priority of users corresponding to the resources occupied by the bearer with the high bearer level, the apparatus compares the respective resources occupied by the different bearers; or
before the reducing the congestion threshold of the cell and/or reduces the service rate of the bearer with the low bearer level, compare priorities of users corresponding to the resources occupied by the different bearers, wherein if a priority of users corresponding to the resources occupied by the bearer with the low bearer level is lower than or equal to a priority of users corresponding to the resources occupied by the bearer with the high bearer level, the apparatus reduces the congestion threshold of the cell and/or reduces the service rate of the bearer with the low bearer level,
wherein when the number of users corresponding to resources occupied by each type of bearer is greater than 1, a priority of the users corresponding to the resources occupied by each type of bearer is an average priority of all users corresponding to the resources occupied by the bearer.

17. The system according to claim 12, the apparatus is further configured to acquire bearer levels of the different bearers.

18. The system according to claim 17, wherein the bearer level is acquired by:
determining the bearer level according to an average throughput demand of all or a part of services in a bearer, wherein a bearer level of a bearer with a high average throughput demand of all or a part of services in a bearer is higher than a bearer level of a bearer with a low average throughput demand of all or a part of services in a bearer; or
determining the bearer level according to an average priority of all or a part of users in a bearer, wherein a bearer level of a bearer with a high average priority of all or a part of users in a bearer is higher than a bearer level of a bearer with a low average priority of all or a part of users in a bearer; or
determining the bearer level according to a scheduling priority of all or a part of services in a bearer, wherein a bearer level of a bearer with a high average scheduling priority of all or a part of services in the bearer is higher than a bearer level of a bearer with a low average scheduling priority of all or a part of services in a bearer; or
acquiring the bearer level according to demands of an operator, wherein a bearer level of a bearer with a high priority of the demands of the operator is higher than a bearer level of a bearer with a low priority of the demands of the operator; or
determining the bearer level according to a sum of throughput demands of all or a part of services in a bearer, wherein a bearer level of a bearer with a high sum of throughput demands of all or a part of services in the bearer is higher than a bearer level of a bearer with a low sum of throughput demands of all or a part of services in a bearer.

19. The system according to claim 12, wherein the different bearers comprise: R99 and high speed packet access (HSPA).

20. The system according to claim 19, wherein the bear level of HSPA is higher than R99.
